(19) United States
(12) Patent Application Publication
(10) Pub. No.: US 2009/0218087 A1
(43) Pub. Date: Sep. 3, 2009

(54) Thermal conduction structure, composite material, and method of producing the material

(75) Inventor: Hisayoshi Oshima, Obu-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/380,276

(22) Filed: Feb. 25, 2009

(30) Foreign Application Priority Data
Feb. 29, 2008 (JP) 2008-050155
Feb. 29, 2008 (JP) 2008-050156

(51) Int. Cl. F28F 7/00; C09K 5/00

(52) U.S. Cl. 165/185; 252/73

(57) ABSTRACT

A thermal conduction structure includes a heat receiving portion, a heat releasing portion, and actuators disposed between the heat receiving portion and the heat releasing portion. A path is defined from the heat receiving portion to the heat releasing portion through the actuator. The actuator is movable between a first position and a second position to correspond to an energy supplied from outside, and is contact with the heat receiving portion and the heat releasing portion, when the actuator is in the first position. The path has a non-contact part between the heat receiving portion and the heat releasing portion, when the actuator is in the second position.

### CROSS REFERENCE TO RELATED APPLICATION

This application is based on Japanese Patent Application No. 2008-50155 filed on Feb. 29, 2008, and Japanese Patent Application No. 2008-50156 filed on Feb. 29, 2008, the disclosure of which are incorporated herein by reference in its entirety.

### BACKGROUND OF THE INVENTION

1. Field of the Invention

The present invention relates to a thermal conduction structure, a composite material, and a method of producing the composite material.

2. Description of Related Art

A material usually has a constant thermal conductivity or a constant electric conductivity as a physical property. However, JP-A-5-23900, JP-A-11-236636, JP-A-9-329290 (corresponding to U.S. Pat. No. 5,156,087), and JP-A-2000-274976 disclose a structure having a thermal conductivity, which is variable without an appearance change of the structure. The thermal conductivity or the electric conductivity is required to be variable based on a use of the structure and an environment of the structure.

However, a structure disclosed in JP-A-5-23900 is deformed as a whole. A method of fixing the structure onto a heat receiving portion or a heat releasing portion may be limited. A variation of a thermal conductivity of a structure disclosed in JP-A-11-236636 is small due to a material used for the structure. A structure disclosed in JP-A-9-329290 includes two gases having different thermal conductivities. A variation of a thermal conductivity of the structure is limited to a range of the thermal conductivities of the two gases. A variation of a thermal conductivity of a structure disclosed in JP-A-2000-274976 is small. The structure includes a fluid, and a variation of a thermal conductivity of the fluid cannot be large.

### SUMMARY OF THE INVENTION

In view of the foregoing and other problems, it is an object of the present invention to provide a thermal conduction structure, a composite material, and a method of producing the composite material.

According to a first example of the present invention, a thermal conduction structure includes a heat receiving portion, a heat releasing portion, and a plurality of actuators disposed between the heat receiving portion and the heat releasing portion. A path is defined from the heat receiving portion to the heat releasing portion through the actuator. The actuator is movable between a first position and a second position so as to correspond to an energy supplied from outside. The actuator is contact with the heat receiving portion and the heat releasing portion, when the actuator is in the first position. The path has a non-contact part between the heat receiving portion and the heat releasing portion, when the actuator is in the second position.

Accordingly, a variation of a thermal conductivity or an electric conductivity of the thermal conduction structure can be large. The thermal conduction structure can be used for a variety of heat receiving portions and a variety of heat releasing portions.

According to a second example of the present invention, a composite material includes a mix of a first portion made of a first material and a second portion made of a second material. The second material has at least one of a thermal conductivity and an electric conductivity, which is lower than that of the first material, and has a thermal expansion coefficient lower than that of the first material. The first portion has a contact rate to be contact with each other. The contact rate of the first portion is changed when the composite material has a temperature equal to or higher than a predetermined value, such that at least one of a thermal conductivity and an electric conductivity of the composite material is changed.

Accordingly, a variation of the thermal conductivity or the electric conductivity of the composite material can be large. The composite material can be used for a variety of heat receiving portions and a variety of heat releasing portions.

According to a third example of the present invention, a method of producing a composite material includes a mixing of a first material and a second material, and a solidifying the mix of the first material and the second material such that a first portion made of the first material is continuously contact with each other.

Accordingly, a variation of a thermal conductivity or an electric conductivity of the composite material can be large. The composite material can be used for a variety of heat receiving portions and a variety of heat releasing portions.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic side view showing a principle of a thermal conduction structure according to first and second embodiments;

FIG. 2 is a graph showing a relationship between a surface temperature and a thermal conductivity of the thermal conduction structure;

FIG. 3 is a schematic perspective view showing a construction of the thermal conduction structure;

FIG. 4 is a schematic side view showing the thermal conduction structure having a non-contact part;

FIG. 5 is a schematic side view showing the thermal conduction structure not having the non-contact part;

FIG. 6 is a graph showing a relationship between a temperature of a heat receiving portion of the structure and a temperature of a heat releasing portion of the structure;

FIG. 7 is a schematic side view showing a thermal conduction structure according to a third embodiment;

FIG. 8 is a schematic side view showing a thermal conduction structure according to a fourth embodiment;

FIG. 9 is a schematic side view showing a thermal conduction structure according to a fifth embodiment;

FIG. 10 is a schematic side view showing a thermal conduction structure according to a sixth embodiment;

FIG. 11 is a schematic side view showing a thermal conduction structure according to a seventh embodiment;

FIG. 12A is a schematic view showing a composite material according to an eighth embodiment at a high temperature, and FIG. 12B is a schematic view showing the composite material at a low temperature;

FIG. 13A is a schematic view showing another composite material according to an eighth embodiment at a low temperature, and FIG. 13B is a schematic view showing the another composite material at a high temperature;

FIG. 14 is a schematic cross-sectional view showing a composite structure made of the composite material;

FIG. 15 is a view showing thermal conductivities and linear expansion coefficients of materials used for producing the composite material; and

FIG. 16 is a graph showing a relationship between a temperature of a heat receiving portion of the composite structure and a temperature of a heat releasing portion of the composite structure.

### DETAILED DESCRIPTION OF PREFERRED EMBODIMENT

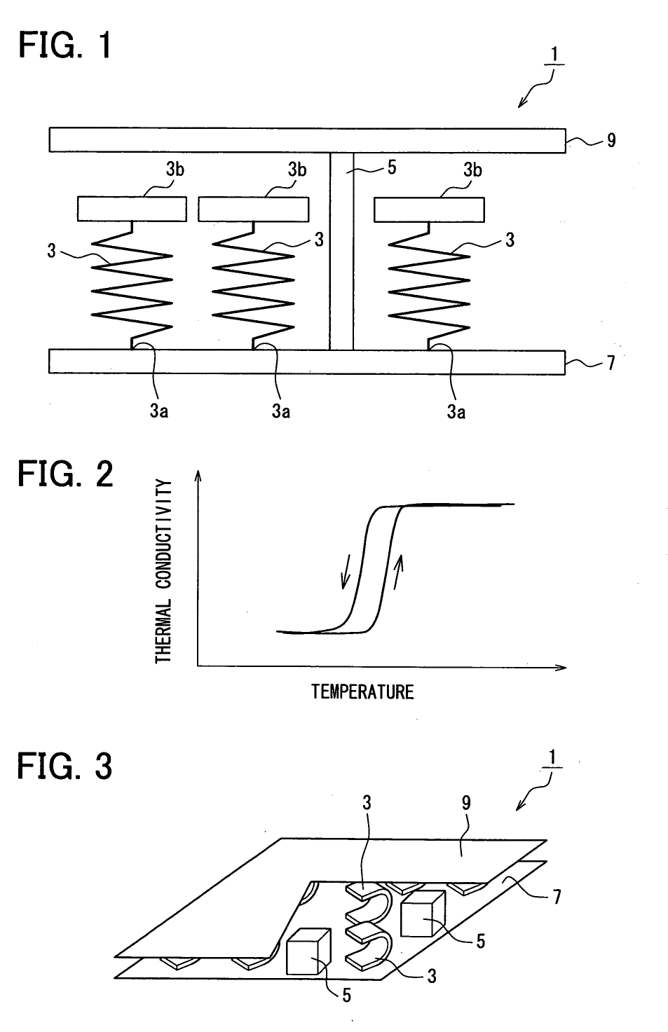

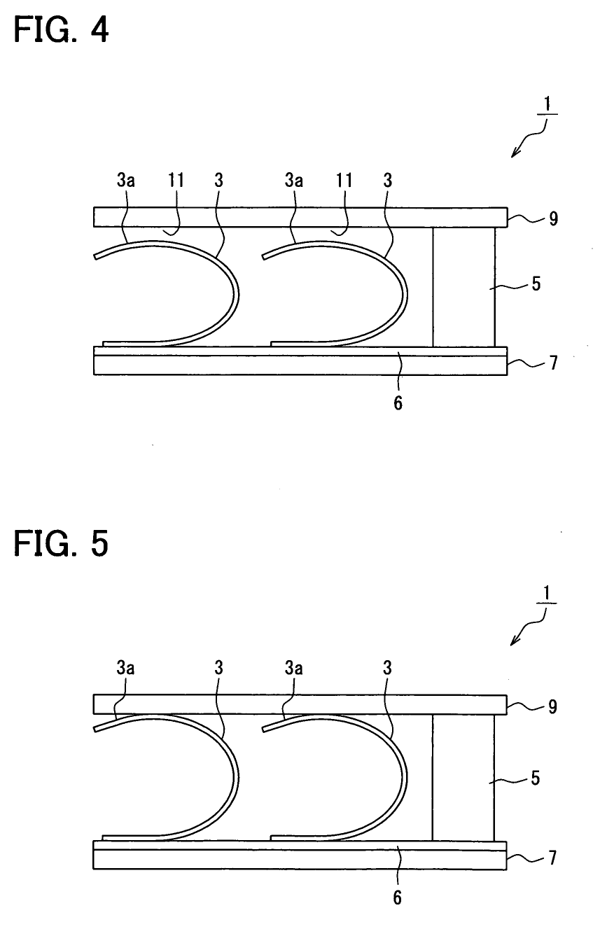

As shown in FIG. 1, a thermal conduction structure 1 includes a heat receiving portion 7, a heat releasing portion 9 and actuators 3 disposed between the heat receiving portion 7 and the heat releasing portion 9. The heat receiving portion 7 may be a heat receiving face, and the heat releasing portion 9 may be a heat releasing face. As shown in FIG. 5, a path is formed from the heat receiving portion 7 to the heat releasing portion 9 through the actuator 3. The actuator 3 is deformable and movable between a first position shown in FIG. 5 and a second position shown in FIG. 4, for example. The actuator 3 is deformable corresponding to an energy supplied from outside.

The heat receiving portion 7 is contact with the actuator 3, and the heat releasing portion 9 is also contact with the actuator 3, when the actuator 3 is in the first position shown in FIG. 5. The path has a non-contact part 11 between the heat receiving portion 7 and the heat releasing portion 9, when the actuator 3 is in the second position shown in FIG. 4.

In FIG. 5, the actuator 3 is contact with both of the heat receiving portion 7 and the heat releasing portion 9. Further, a first contact part between the actuator 3 and the heat receiving portion 7, and a second contact part between the actuator 3 and the heat releasing portion 9 may be integrated with each other.

In FIG. 4, the actuator 3 is not contact with the heat releasing portion 9. Alternatively, the actuator 3 may not be contact with the heat receiving portion 7 in place of the heat releasing portion 9. Alternatively, a first contact part between the actuator 3 and the heat receiving portion 7, and a second contact part between the actuator 3 and the heat releasing portion 9 may be separated from each other.

Thus, a variation of a thermal conductivity between the heat receiving portion 7 and the heat releasing portion 9 can be large. That is, the thermal conductivity is large when the actuator 3 is in the first position shown in FIG. 5, and the thermal conductivity is small when the actuator 3 is in the second position shown in FIG. 4.

As shown in FIG. 1, the actuator 3 has a first end 3a and a second end 3b. The first end 3a of the actuator 3 is continuously contact with one of the heat receiving portion 7 and the heat releasing portion 9, and the second end 3b of the actuator 3 is contact with other of the heat receiving portion 7 and the heat releasing portion 9, when the actuator 3 is in the first position. The second end 3b of the actuator 3 is not contact with other of the heat receiving portion 7 and the heat releasing portion 9, when the actuator 3 is in the second position.

The first end 3a of the actuator 3 is continuously contact with the heat receiving portion 7, as shown in FIG. 1. Thus, a movement of the actuator 3 can quickly correspond to a temperature change of the heat receiving portion 7.

The first end 3a of the actuator 3 may be continuously contact with the heat releasing portion 9. Thus, a timing of the movement of the actuator 3 can be delayed compared with a case in which the first end 3a of the actuator 3 is continuously contact with the heat receiving portion 7.

The thermal conduction structure 1 may further include a support member 5 disposed between the heat receiving portion 7 and the heat releasing portion 9. The support member 5 supports the heat receiving portion 7 and the heat releasing portion 9. The actuator 3 may include a bimetal and/or a shape-memory alloy deformable to correspond to a thermal energy supplied from outside of the actuator 3.

As shown in FIG. 7, the actuator 3 may include a sack member 12 made of an elastic material. The sack member 12 is sealed to have a gas inside, such that the sack member 12 expands or contracts so as to be deformable to correspond to a thermal energy supplied from outside.

The actuator 3 is in the first position without the non-contact part 11, when the actuator 3 has a temperature equal to or higher than a predetermined value, for example. The actuator 3 is in the second position with the non-contact part 11, when the actuator 3 has a temperature lower than the predetermined value.

In this case, the heat receiving portion 7 may be an engine of an automotive vehicle, and the heat releasing portion 9 may be an exhaust pipe or a water-cooled radiator. When a temperature of the engine is low during a warm-up, heat releasing from the engine can be reduced. When the temperature of the engine becomes high, heat of the engine can be quickly released to the exhaust pipe or the water-cooled radiator.

A temperature for changing the actuator 3 from the first position to the second position can be made different from a temperature for changing the actuator 3 from the second position to the first position by changing characteristics of the bimetal or the shape-memory alloy, for example. In this case, as shown in FIG. 2, hysteresis is generated between a surface temperature of the heat receiving portion 7 or the heat releasing portion 9, and a thermal conductivity between the heat receiving portion 7 and the heat releasing portion 9.

When the actuator 3 has a temperature equal to or higher than a predetermined value, the actuator 3 may be in the second position with the non-contact part 11. When the actuator 3 has a temperature lower than the predetermined value, the actuator 3 may be in the first position without the non-contact part 11. In this case, the thermal conduction structure 1 may be used for a keep-warm pot having a double structure, for example. That is, an inner wall of the keep-warm pot may be the heat receiving portion 7, and an outer wall of the keep-warm pot may be the heat releasing portion 9. When the keep-warm pot has a high-temperature liquid inside, a thermal conductivity can be made low. Thus, the high-temperature liquid can be kept hot.

The actuator 3 may include a solenoid, which is operable to correspond to an electric energy supplied from outside. The actuator 3 may include a magnet, which is operable to correspond to a magnetic energy supplied from outside.

Embodiments are described with reference to FIGS. 1-16.

### First Embodiment

A method of manufacturing a thermal conduction structure 1 will be described with reference to FIGS. 3 and 4. A bimetal is processed to have a U-shape so as to produce an actuator 3. The bimetal is processed such that the U-shape is to be open when the actuator 3 is heated. The actuator 3 is a cuboid having a bottom face of 2 mm×2 mm, and a height of 1 mm. A plurality of the actuators 3 is manufactured.

Further, a support member 5 is an epoxy resin coated with a hot-melt having a bottom face of 2 mm×2 mm, and a height of 1.1 mm. A plurality of the support members 5 is manufactured.

A heat receiving portion 7 is a copper board having an area of 100 mm×100 mm, and a thickness of 0.5 mm. The actuators 3 are mounted on a whole top face of the copper board through a braze 6 shown in FIG. 4. The actuators 3 are arrayed with a predetermined interval in each of a left-and-right direction and a front-and-rear direction of the copper board of FIG. 3. At this time, a dummy epoxy resin (not shown) having a bottom face of 2.5 mm×2.5 mm, and a height of 1mm is disposed in a space in which the support member 5 is to be located. After the dummy epoxy resin is removed, the support member 5 is mounted in the space.

The heat releasing portion 9 is a copper board having an area of 100 mm×100 mm, and a thickness of 0.5 mm. The heat releasing portion 9 covers the actuator 3 and the support member 5 disposed on the heat receiving portion 7, and is pressurized with a temperature of 150° C. Thus, the heat receiving portion 7 and the heat releasing portion 9 are connected to each other through the support member 5. A periphery of the heat receiving portion 7 and the heat releasing portion 9 is sealed with a silicon resin. As shown in FIG. 4, when the heat receiving portion 7 is not heated, a clearance corresponding to the non-contact part 11 is generated between the first end 3a of the actuator 3 and the heat releasing portion 9.

An operation of the thermal conduction structure 1 will be described. The thermal conduction structure 1 is disposed on a hot plate with the heat receiving portion 7 to be a bottom side. The thermal conduction structure 1 is heated in this state. A temperature of the heat receiving portion 7 is gradually increased from a room temperature to 250° C. When the temperature of the heat receiving portion 7 becomes equal to or higher than a predetermined value, as shown in FIG. 5, the U-shape of the actuator 3 opens such that the first end 3a of the actuator 3 contacts the heat releasing portion 9. At this time, a path extending from the heat receiving portion 7 through the actuator 3 to the heat releasing portion 9 is disabled to have the non-contact part 11. This state continues until when the temperature of the heat receiving portion 7 becomes 250° C. The temperature of the heat receiving portion 7 is decreased after the heating of the hot plate is stopped. When the temperature of the heat receiving portion 7 becomes lower than the predetermined value, the U-shape of the actuator 3 closes such that the path is able to have the non-contact part 11 between the first end 3a of the actuator 3 and the heat releasing portion 9.

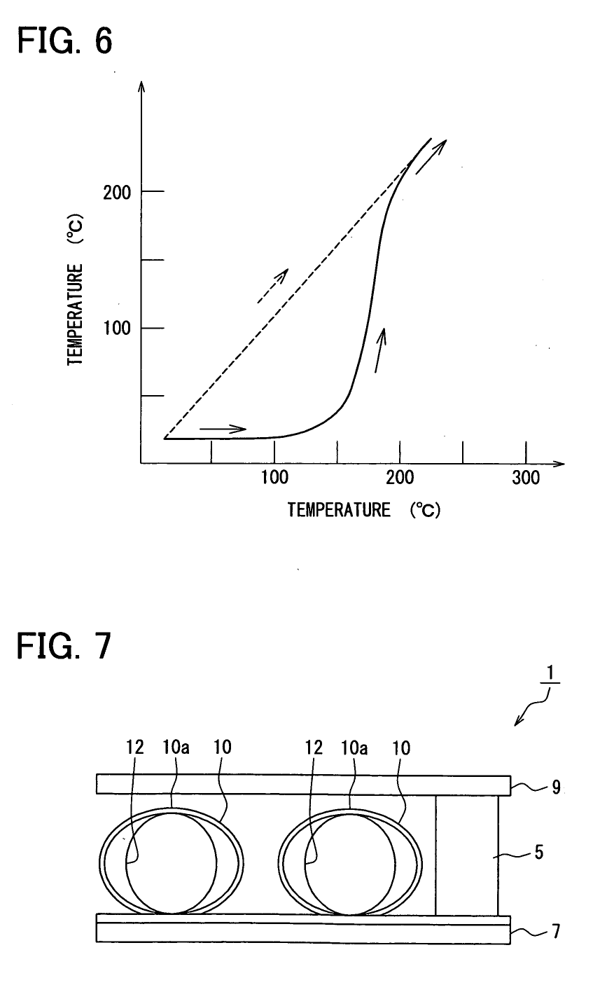

A temperature variation of the heat releasing portion 9 is shown in a y-axis of a solid line of FIG. 6, while a temperature of the heat receiving portion 7 is increased, which corresponds to an x-axis of the solid line of FIG. 6. As a comparison example, a temperature variation of a single copper plate is shown in a dashed line of FIG. 6 while the single copper plate is heated on the hot plate with the same condition. An increasing rate of the temperature of the heat releasing portion 9 is small until when the temperature of the heat receiving portion 7 becomes about 150° C. This is because the first end 3a of the actuator 3 does not contact the heat releasing portion 9. That is, a thermal conductivity from the heat receiving portion 7 to the heat releasing portion 9 is low. After the temperature of the heat receiving portion 7 exceeds 150° C., the increasing rate of the temperature of the heat releasing portion 9 becomes large. This is because the first end 3a of the actuator 3 contacts the heat releasing portion 9. The thermal conductivity from the heat receiving portion 7 to the heat releasing portion 9 becomes large, because a thermal conduction path is generated from the heat receiving portion 7 through the actuator 3 to the heat releasing portion 9. In contrast, an increasing rate of a temperature of the single copper plate of the comparison example is constant.

Effect of the heat conduction structure 1 will be described. As shown in FIG. 6, the variation of the thermal conductivity of the heat conduction structure 1 can be made large. The heat conduction structure 1 can be used for a heat receiving portion or a heat releasing portion having a variety of sizes or shapes by adjusting a height or size of the actuator 3. The heat conduction structure 1 can have a simple construction.

When the temperature of the heat receiving portion 7 is low, the thermal conductivity of the thermal conduction structure 1 can be made low. When the temperature of the heat receiving portion 7 is high, the thermal conductivity of the thermal conduction structure 1 can be made high. For example, the heat receiving portion 7 may be an engine of an automotive vehicle, and the heat releasing portion 9 may be an exhaust pipe or a water-cooled radiator. When a temperature of the engine is low during a warm-up, heat releasing from the engine can be reduced. When the temperature of the engine is increased, heat of the engine can be quickly released to the exhaust pipe or the water-cooled radiator.

### Second Embodiment

Operation of an actuator 3 of a thermal conduction structure 1 of a second embodiment is different from that of the first embodiment. When the actuator 3 is not heated, a U-shape of the actuator 3 opens such that a first end 3a of the actuator 3 contacts a copper board corresponding to a heat releasing portion 9. In contrast, when the actuator 3 is heated, the U-shape of the actuator 3 closes such that a non-contact part 11 is generated between the first end 3a of the actuator 3 and the heat releasing portion 9. Therefore, the thermal conduction structure 1 of the second embodiment has a high thermal conductivity when the heat receiving portion 7 is not heated. The thermal conduction structure 1 of the second embodiment has a low thermal conductivity when the heat receiving portion 7 is heated. The actuator 3 of the second embodiment is manufactured by converting a direction of a bimetal between an inner side and an outer side from the first embodiment.

The thermal conduction structure 1 may be used for a keep-warm pot having a double structure, for example. That is, an inner wall of the keep-warm pot may be the heat receiving portion 7, and an outer wall of the keep-warm pot may be the heat releasing portion 9. When the keep-warm pot has a high-temperature liquid inside, a thermal conductivity can be made low. Thus, the high-temperature liquid can be kept hot.

### Third Embodiment

A thermal conduction structure 1 of a third embodiment has a construction shown in FIG. 7. A heat receiving portion 7 and a heat releasing portion 9 are connected to each other through a support member 5, similar to the first embodiment. A plurality of actuators 3 is mounted on a whole top face of the heat receiving portion 7, similar to the first embodiment.

The actuator 3 is constructed with a tube 10 made of phosphor bronze and a sack member 12, which has air inside and is made of silicon rubber. The tube 10 has a cross-section of an oval shape. A side face of the tube 10 is brazed to the heat receiving portion 7. At this time, a major axis direction of the cross-section of the tube 10 is parallel to the heat receiving portion 7 and the heat releasing portion 9.

The sack member 12 is made of silicon rubber, and has a sphere shape. Air is sealed in the sack member 12. The sack member 12 is disposed inside of the tube 10. Both of an upper end and a bottom end of the sack member 12 contact an inner wall of the tube 10. A clearance is generated between a left-and-right end of the sack member 12 and the inner wall of the tube 10, as shown in FIG. 7.

When the heat receiving portion 7 is not heated, a clearance is generated between a top end 10a of the tube 10 and the heat releasing portion 9. At this time, the heat receiving portion 7 and the heat releasing portion 9 are not contact with each other through the actuator 3. Therefore, a thermal conductivity is low between the heat receiving portion 7 and the heat releasing portion 9.

When the heat receiving portion 7 is heated, the sack member 12 expands. Then, the top end 10a of the tube 10 is pushed upward to be contact with the heat releasing portion 9. At this time, a thermal circuit is defined to connect the heat receiving portion 7, the tube 10 and the heat releasing portion 9. Therefore, the thermal conductivity becomes high between the heat receiving portion 7 and the heat releasing portion 9. When the heating of the heat receiving portion 7 is stopped, the sack member 12 contracts. Again, a clearance is generated between a top end 10a of the tube 10 and the heat releasing portion 9.

Thus, the actuator 3 of the thermal conduction structure 1 is activated by a thermal energy supplied from outside such that a thermal conductivity can be changed between the heat receiving portion 7 and the heat releasing portion 9.

### Fourth Embodiment

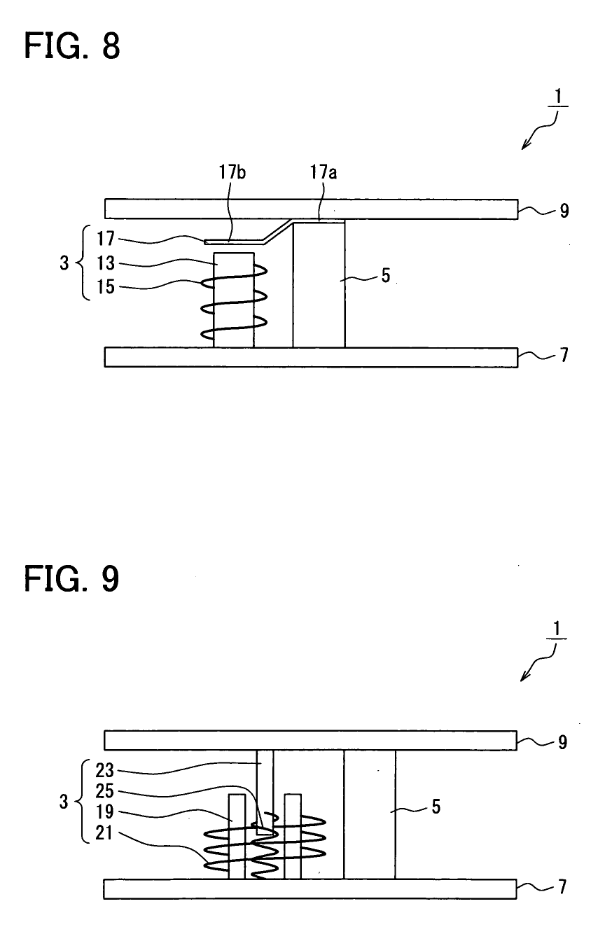

A thermal conduction structure 1 of a fourth embodiment has a construction shown in FIG. 8. Similar to the first embodiment, a heat receiving portion 7 and a heat releasing portion 9 are connected to each other through a support member 5. Actuators 3 are mounted on a whole top face of the heat receiving portion 7.

The actuator 3 is constructed with an iron core 13, a solenoid 15, and an iron foil 17. The iron core 13 has a diameter of 2 mm, and a length of 3 mm. An end of the iron core 13 is brazed to the heat receiving portion 7. A clearance is defined between the iron core 13 and the heat releasing portion 9. The solenoid 15 is an enamel wire winded around the iron core 13, and is connected to an external energy source (not shown). When a current passes through the solenoid 15, the iron core 13 and the solenoid 15 operate as an electromagnet.

A first end 17a of the iron foil 17 is fixed between the support member 5 and the heat releasing portion 9. Thus, the iron foil 17 is always contact with the heat releasing portion 9. A second end 17b of the iron foil 17 is located between the iron core 13 and the heat releasing portion 9.

When a current does not pass through the solenoid 15, the electromagnet constructed with the iron core 13 and the solenoid 15 is not activated. The second end 17b of the iron foil 17 does not contact either the heat releasing portion 9 or the iron core 13. At this time, the heat receiving portion 7 and the heat releasing portion 9 are not contact with each other through the actuator 3. Thus, a thermal conductivity is low between the heat receiving portion 7 and the heat releasing portion 9.

When a current passes through the solenoid 15, the electromagnet constructed with the iron core 13 and the solenoid 15 is activated. The second end 17b of the iron foil 17 contacts the iron core 13 by a magnetic force. A thermal circuit is defined to connect the heat receiving portion 7, the iron core 13, the iron foil 17, and the heat releasing portion 9. Thus, a thermal conductivity becomes high between the heat receiving portion 7 and the heat releasing portion 9.

Thus, the actuator 3 of the thermal conduction structure I is activated by an electric energy supplied from outside such that a thermal conductivity can be changed between the heat receiving portion 7 and the heat releasing portion 9.

### Fifth Embodiment

A thermal conduction structure 1 of a fifth embodiment has a construction shown in FIG. 9. Similar to the first embodiment, a heat receiving portion 7 and a heat releasing portion 9 are connected to each other through a support member 5. Actuators 3 are mounted on a whole top face of the heat receiving portion 7.

The actuator 3 is constructed with a hollow bobbin 19, an enamel wire 21, an iron core 23 and a spring 25. The hollow bobbin 19 has an inner diameter of 2 mm, and a length of 2 mm. The enamel wire 21 is winded around the hollow bobbin 19, and is connected to an external energy source (not shown). When a current passes through the enamel wire 21, the hollow bobbin 19 and the enamel wire 21 operate as an electromagnet. The spring 25 is disposed in the hollow bobbin 19, and a first end of the spring 25 is fixed to the heat receiving portion 7. Further, a second end of the spring 25 is connected to the iron core 23 such that the iron core 23 is biased toward the heat releasing portion 9.

When a current does not pass through the enamel wire 21, the hollow bobbin 19 and the enamel wire 21 does not operate as the electromagnet. The iron core 23 contacts the heat releasing portion 9 due to a biasing force of the spring 25. At this time, a thermal circuit is defined to connect the heat receiving portion 7, the spring 25, the iron core 23, and the heat releasing portion 9. Thus, a thermal conductivity becomes high between the heat receiving portion 7 and the heat releasing portion 9.

When a current passes through the enamel wire 21, the electromagnet constructed with the hollow bobbin 19 and the enamel wire 21 is activated. The iron core 23 is pulled into the hollow bobbin 19, and a clearance is generated between the iron core 23 and the heat releasing portion 9. At this time, the heat receiving portion 7 and the heat releasing portion 9 are not contact with each other through the actuator 3. Thus, a thermal conductivity is low between the heat receiving portion 7 and the heat releasing portion 9.

Thus, the actuator 3 of the thermal conduction structure 1 is activated by an electric energy supplied from outside such that a thermal conductivity can be changed between the heat receiving portion 7 and the heat releasing portion 9.

### Sixth Embodiment

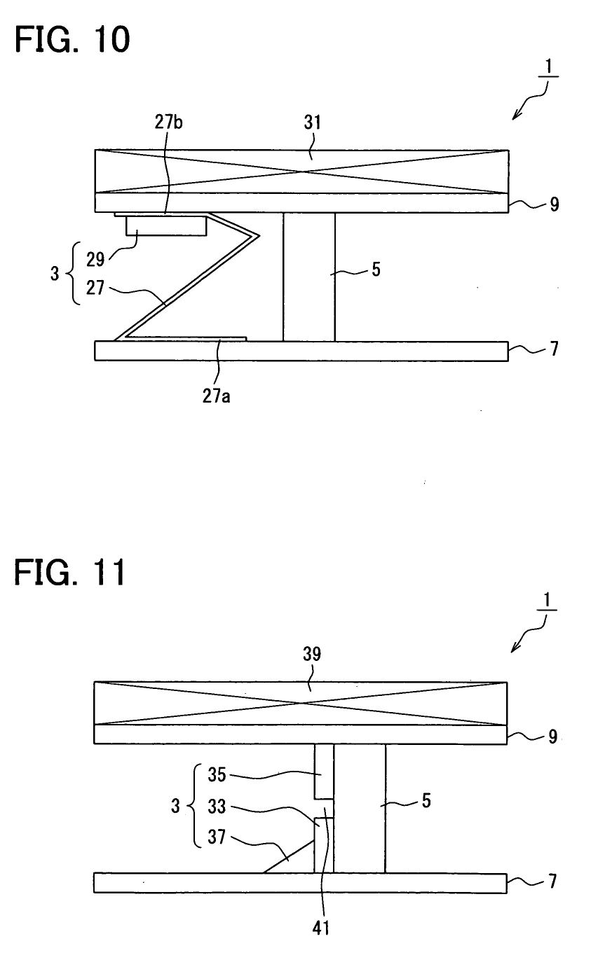

A thermal conduction structure 1 of a sixth embodiment has a construction shown in FIG. 10. Similar to the first embodiment, a heat receiving portion 7 and a heat releasing portion 9 are connected to each other through a support member 5. Actuators 3 are mounted on a whole top face of the heat receiving portion 7.

The actuator 3 is constructed with a spring board 27 made of phosphor bronze, and a permanent magnet 29. Further, an electromagnet 31 is mounted on a top face of the heat releasing portion 9.

The spring board 27 has an approximately Z-shape, and a bottom face 27a of the spring board 27 is brazed to the heat receiving portion 7. The permanent magnet 29 is mounted on a low side of a top face 27b of the spring board 27.

When the electromagnet 31 is not activated, the top face 27b of the spring board 27 contacts the heat releasing portion 9. At this time, a thermal circuit is defined to connect the heat receiving portion 7, the spring board 27, and the heat releasing portion 9. Thus, a thermal conductivity becomes high between the heat receiving portion 7 and the heat releasing portion 9.

When the electromagnet 31 is activated, the electromagnet 31 and the permanent magnet 29 repel each other. Then, the spring board 27 is deformed due to a repulsion between the electromagnet 31 and the permanent magnet 29. The top face 27b of the spring board 27 is separated from the heat releasing portion 9. At this time, the heat receiving portion 7 and the heat releasing portion 9 are not contact with each other through the actuator 3. Thus, a thermal conductivity is low between the heat receiving portion 7 and the heat releasing portion 9.

Thus, the actuator 3 of the thermal conduction structure 1 is activated by a magnetic energy supplied from outside such that a thermal conductivity can be changed between the heat receiving portion 7 and the heat releasing portion 9.

### Seventh Embodiment

A thermal conduction structure 1 of a seventh embodiment has a construction shown in FIG. 11. Similar to the first embodiment, a heat receiving portion 7 and a heat releasing portion 9 are connected to each other through a support member 5. Actuators 3 are mounted on a whole top face of the heat receiving portion 7.

The actuator 3 is constructed with a pair of iron boards 33, 35 and a magnetic fluid 37. Further, an electromagnetic 39 is mounted on a top face of the heat releasing portion 9.

An end of the iron board 33 is brazed to the heat receiving portion 7 such that a longitudinal direction of the iron board 33 corresponds to a longitudinal direction of the support member 5. An end of the iron board 35 is brazed to the heat releasing portion 9 such that a longitudinal direction of the iron board 35 corresponds to a longitudinal direction of the support member 5. A clearance 41 having a dimension of 1 mm is located between the iron boards 33, 35 in the longitudinal direction of the iron boards 33, 35. The magnetic fluid 37 has a volume equal to or larger than a volume of the clearance 41.

When the electromagnet 39 is not activated, the magnetic fluid 37 is not located in the clearance 41. Therefore, the iron boards 33, 35 are not connected to each other. At this time, the heat receiving portion 7 and the heat releasing portion 9 are not contact with each other through the actuator 3. Thus, a thermal conductivity is low between the heat receiving portion 7 and the heat releasing portion 9.

When the electromagnet 39 is activated, the magnetic fluid 37 is pulled toward the clearance 41 so as to connect the iron boards 33, 35. At this time, a thermal circuit is defined to connect the heat receiving portion 7, the iron board 33, the magnetic fluid 37, the iron board 35, and the heat releasing portion 9. Thus, a thermal conductivity becomes high between the heat receiving portion 7 and the heat releasing portion 9.

Thus, the actuator 3 of the thermal conduction structure 1 is activated by a magnetic energy supplied from outside such that a thermal conductivity can be changed between the heat receiving portion 7 and the heat releasing portion 9.

For example, a shape-memory alloy may be used in place of the bimetal as a material of the actuator 3 in the first and second embodiments.

Such changes and modifications are to be understood as being within the scope of the present invention as defined by the appended claims.

### Eighth Embodiment

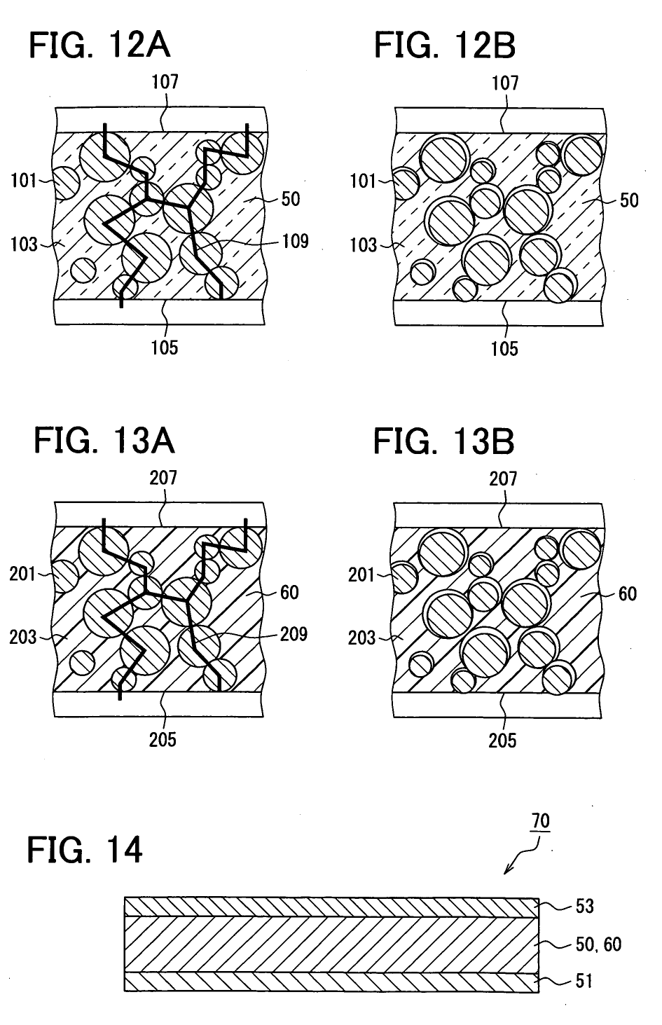

As shown in FIG. 12A, a composite material 50 is a mix of a first portion 101 made of a first material and a second portion 103 made of a second material. The second material has at least one of a thermal conductivity and an electric conductivity lower than that of the first material. The second material has a thermal expansion coefficient lower than that of the first material. When the composite material 50 has a high temperature, expansion of the first material is large relative to that of the second material. As shown in FIG. 12A, the first portion 101 has a contact rate to be contact with each other, and the contact rate is increased when the composite material 50 has a high temperature. Thus, the first portion 101 is continuously connected to each other such that a high-conduction path 109 can be easily defined from a heat receiving portion 105 to a heat releasing portion 107. The heat receiving portion 105 may be a heat receiving face, and the heat releasing portion 107 may be a heat releasing face. Here, the first material has at least one of a thermal conductivity and an electric conductivity higher than that of the second material. Therefore, at least one of a thermal conductivity and an electric conductivity of the composite material 50 becomes high due to the high-conduction path 109.

In contrast, when the composite material 50 has a low temperature, contraction of the first material is larger than that of the second material. As shown in FIG. 12B, the contact rate of the first portion 101 is decreased when the composite material 50 has a low temperature. Thus, the high-conduction path 109 is not generated. Therefore, at least one of the thermal conductivity and the electric conductivity of the composite material 50 becomes low.

Accordingly, at least one of the thermal conductivity and the electric conductivity of the composite material 50 can be widely changed based on a temperature of the composite material 50. Further, the composite material 50 can be used between a heat receiving portion or a heat releasing portion having a variety of sizes or shapes, by only changing a shape or size of the composite material 50.

As shown in FIG. 13A, a composite material 60 is a mix of a first portion 201 made of a first material and a second portion 203 made of a second material. The second material has at least one of a thermal conductivity and an electric conductivity lower than that of the first material. The second material has a thermal expansion coefficient lower than that of the first material. When the composite material 60 has a low temperature, contraction of the second material is larger than that of the first material. As shown in FIG. 13A, the first portion 201 has a contact rate to be contact with each other, and the contact rate is increased when the composite material 60 has a low temperature. Thus, the first portion 201 is continuously connected to each other such that a high-conduction path 209 can be easily defined from a heat receiving portion 205 to a heat releasing portion 207. Here, the first material has at least one of a thermal conductivity and an electric conductivity higher than that of the second material. Therefore, at least one of a thermal conductivity and an electric conductivity of the composite material 60 becomes high due to the high-conduction path 209.

In contrast, when the composite material 60 has a high temperature, expansion of the second material is larger than that of the first material. As shown in FIG. 13B, the contact rate of the first portion 201 is decreased when the composite material 60 has a high temperature. Thus, the high-conduction path 209 is not generated. Therefore, at least one of the thermal conductivity and the electric conductivity of the composite material 60 becomes low.

Accordingly, at least one of the thermal conductivity and the electric conductivity of the composite material 50, 60 can be widely changed based on a temperature of the composite material 50, 60. Further, the composite material 50, 60 can be used between a heat receiving portion or a heat releasing portion having a variety of sizes or shapes, by only changing a shape or size of the composite material 50, 60.

For example, a metal material such as silver, copper, invar and so on may be used as the first material. An inorganic oxide such as silica may be used as the second material. A polymer compound such as epoxy resin may be used as the second material. A composite of the inorganic oxide and the polymer compound may be used as the second material. The second material may have a thermal conductivity lower than that of the first material. The second material may have an electric conductivity lower than that of the first material. The second material may have a thermal conductivity lower than that of the first material, and may have an electric conductivity lower than that of the first material.

For example, the first material may have a particle shape. In this case, the first portion 101, 201 made of the first material may be constructed with a single particle or plural particles. For example, the second material may have a particle shape. Alternatively, as shown in FIGS. 12A and 13A, the second portion 103, 203 made of the second material may be integrated.

The composite material 50, 60 may be produced by mixing the first material and the second material, and solidifying the mix of the first material and the second material such that the first portion 101, 201 is continuously contact with each other.

At this time, the first portion 101, 201 may be made to continuously contact with each other by pressurizing the mix of the first material and the second material. Further, the first portion 101, 201 can be made to continuously contact with each other by settling the mix of the first material and the second material, and precipitating the first material having a specific gravity larger than that of the second material. In the precipitating, the first material may be exposed from a surface of the composite material 50, 60. Thus, the first portion 101, 201 can be secured to continuously contact with each other In the producing of the composite material 50, a temperature of the composite material 50 is set to be higher than the predetermined value in the solidification, when the thermal expansion coefficient of the second material is smaller than that of the first material.

In the producing of the composite material 60, a temperature of the composite material 60 is set to be lower than the predetermined value in the solidification, when the thermal expansion coefficient of the second material is larger than that of the first material. Thereby, the thermal conductivity or the electric conductivity of the composite material 50, 60 can be widely changed at a boundary of the predetermined value.

As shown in FIG. 14, a composite structure 70 is constructed with a first copper foil 51, a second copper foil 53, and the composite material 50, 60. The composite material 50, 60 is disposed between the first copper foil 51 and the second copper foil 53.

At least one of the thermal conductivity and the electric conductivity can be widely changed between the first copper foil 51 and the second copper foil 53 based on a temperature of the composite structure 70.

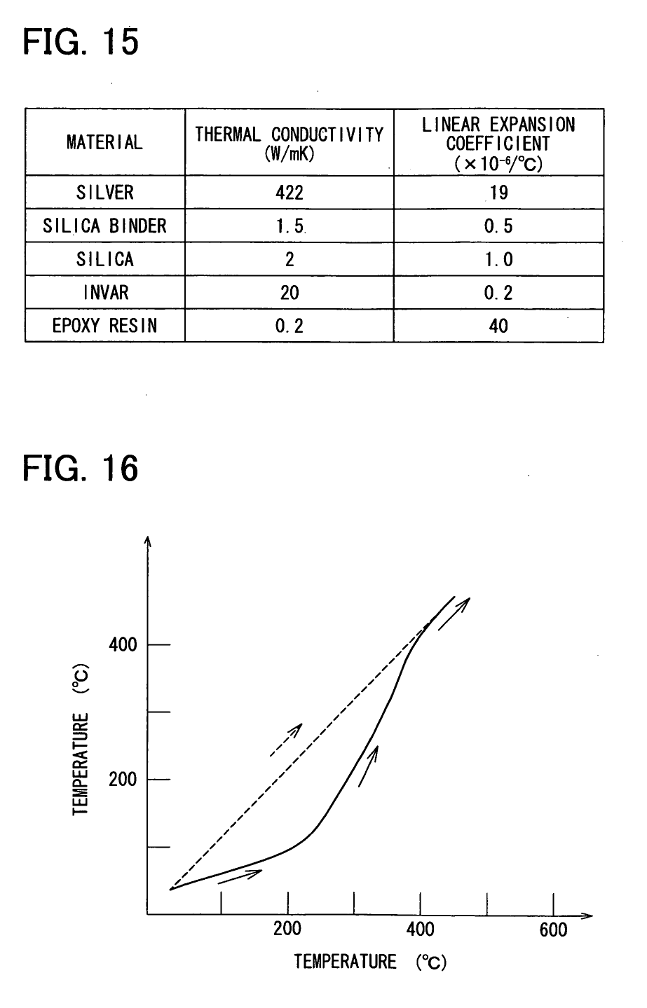

A producing of the composite material 50 and the composite structure 70 is specifically described with reference to FIGS. 15 and 16.

Silver powder, silica binder, and silica sphere are mixed at a weight ratio of 5:5:1. The silver powder has an average size of 20 μm. The silica binder includes siloxane. The silica sphere has an average diameter of 100 μm. Here, the silver powder, the silica binder, and the silica sphere have each thermal conductivity and linear expansion coefficient shown in FIG. 15. The linear expansion coefficient corresponds to a thermal expansion coefficient.

As shown in FIG. 15, the thermal conductivity and the linear expansion coefficient of the silica binder is smaller than those of silver. The silver powder corresponds to the first material, and the silica binder corresponds to the second material. Further, the silica sphere is used to control a thickness of the composite material 50.

The mix of the silver powder, the silica binder, and the silica sphere is cast on the first copper foil 51, and sandwiched between the first copper foil 51 and the second copper foil 53. The mix of the silver powder, the silica binder, and the silica sphere is pressed with a pressure of 40 g/cm² until when the copper foils 51, 53 are electrically contact with each other. Then, the mix of the silver powder, the silica binder, and the silica sphere is calcined with a temperature of 600° C. in the pressed condition. Thus, as shown in FIG. 14, the composite material 50 can be formed between the first copper foil 51 and the second copper foil 53. The composite structure 70 can be used as a sheet having a thermal conductivity, which is variable.

The composite structure 70 constructed with the copper foils 51, 53 and the composite material 50 is placed on a hot plate in a condition that the first copper foil 51 is to be a bottom side. The composite structure 70 is heated in the situation such that a temperature of the first copper foil 51 is gradually increased from a room temperature to 450° C.

A temperature variation of the second copper foil 53 is shown in a y-axis of a solid line of FIG. 16, while the temperature of the first copper foil 51 is increased, which corresponds to an x-axis of the solid line of FIG. 16. As a comparison example, a temperature variation of a single copper board is shown in a dashed line of FIG. 16 when the single copper board is similarly heated on the hot plate. The temperature of the second copper foil 53 is slowly increased until when the temperature of the first copper foil 51 becomes around 200° C., which corresponds to a predetermined temperature. This is because a thermal expansion of the silver powder is not sufficient when the temperature of the first copper foil 51 is low. The silver powder is not contact with each other. Therefore, a thermal conductivity is low from the first copper foil 51 to the second copper foil 53.

After the temperature of the first copper foil 51 exceeds 200° C., the temperature of the second copper foil 53 is quickly increased. This is because the silver powder thermally expands when the temperature of the first copper foil 51 becomes high. The silver powder is continuously contact with each other. The thermal conduction path 109 of the silver powder is generated from the heat receiving portion 105 corresponding to the first copper foil 51 to the heat releasing portion 107 corresponding to the second copper foil 53. Thus, the thermal conductivity becomes high from the heat receiving portion 105 to the heat releasing portion 107. In contrast, the temperature of the copper board of the comparison example is constantly increased. Further, an electric conductivity of a sheet made of the composite material 50 has the same characteristic as the thermal conductivity of the sheet made of the composite material 50.

The thermal conductivity of the composite material 50 can be low when the first copper foil 51 corresponding to the heat receiving portion 105 has a low temperature. The thermal conductivity of the composite material 50 can be high when the first copper foil 51 corresponding to the heat receiving portion 105 has a high temperature. For example, the heat receiving portion 105 may be an engine of an automotive vehicle, and the heat releasing portion 107 may be an exhaust pipe or a water-cooled radiator. When a temperature of the engine is low during a warm-up, heat releasing from the engine can be reduced. When the temperature of the engine is increased, heat of the engine can be quickly released to the exhaust pipe or the water-cooled radiator.

### Ninth Embodiment

A producing of a composite material 60 and a composite structure 70 will be described.

Invar powder, epoxy resin, and silica sphere are mixed at a weight ratio of 5:5:1. The invar powder is an iron-nickel alloy, and has an average size of 20 μm. The silica sphere has an average diameter of 1000 μm. Here, the invar powder, the epoxy resin, and the silica sphere have each thermal conductivity and linear expansion coefficient shown in FIG. 15. The linear expansion coefficient corresponds to a thermal expansion coefficient.

As shown in FIG. 15, the thermal conductivity of the epoxy resin is smaller than that of the invar, and the linear expansion coefficient of the epoxy resin is larger than that of the invar. The invar powder corresponds to the first material, and the epoxy resin corresponds to the second material. Further, the silica sphere is used to control a thickness of the composite material 60.

The mix of the invar powder, the epoxy, and the silica sphere is cast on a first copper foil 51, and sandwiched with a second copper foil 53. The mix is pressed with a pressure of 40 g/cm² at a room temperature until when the copper foils 51, 53 are electrically contact with each other. Thus, as shown in FIG. 14, the composite material 60 can be formed between the first copper foil 51 and the second copper foil 53. The composite structure 70 can be used as a thermal conductivity variable sheet.

The composite structure 70 constructed with the copper foils 51, 53 and the composite material 60 is placed on a hot plate in a condition that the first copper foil 51 is to be a bottom side. The composite structure 70 is heated in the situation such that a temperature of the first copper foil 51 is gradually increased from a room temperature to 450° C. At this time, the thermal conductivity of the composite material 60 is high until when the temperature of the first copper foil 51 becomes around 100° C., which corresponds to a predetermined temperature. This is because the epoxy resin does not expand at a low temperature. Continuous contact among the invar powder is maintained, and a thermal conduction path of the invar powder is generated from the first copper foil 51 to the second copper foil 53. Thus, the thermal conductivity becomes high from the first copper foil 51 to the second copper foil 53.

The thermal conductivity of the composite material 60 is quickly decreased when the temperature of the first copper foil 51 exceeds 100° C. This is because the epoxy resin thermally expands. The thermal conduction path of the invar powder is not provided. The invar powder is not contact with each other. Further, an electric conductivity of the composite material 60 has the same characteristic as the thermal conductivity of the composite material 60.

The thermal conductivity of the composite material 60 can be high at a low temperature. The thermal conductivity of the composite material 60 can be low at a high temperature. For example, the composite material 60 may be used for a keep-warm pot having a double structure. That is, an inner wall of the keep-warm pot may be the heat receiving portion 205, and an outer wall of the keep-warm pot may be the heat releasing portion 207. When the keep-warm pot has a high-temperature liquid inside, a thermal conductivity can be made low. Thus, the high-temperature liquid can be kept hot.

### Tenth Embodiment

A producing of a composite material 50 will be described.

Silver powder having an average size of 20 μm, and silica binder including siloxane are mixed at a weight ratio of 5:5. The mix is disposed in a heat-resistant container having a flat bottom, and left for one day. At this time, the silver power is precipitated because a gravity of the silver powder is larger than that of the silica binder. The precipitated silver powder is continuously contact with each other. Then, the mix is calcined at a temperature of 600° C. so as to produce the composite material 50. The composite material 50 is taken from the container, and is cut to have a thickness of 1 mm. In the cutting, it is checked if silver is exposed from both of the heat receiving portion 105 and the heat releasing portion 107 of the composite material 50. If silver is not exposed, the surface of the composite material 50 is ground so that silver is exposed. Thus, the composite material 50 is used as a thermal conduction variable sheet. The sheet has a property approximately equal to that of the sheet produced in the eighth embodiment.

The composite material 50, 60 may be produced by using three or more materials. The composite material 50, 60 may be produced by using the same materials having different particle sizes.

Such changes and modifications are to be understood as being within the scope of the present invention as defined by the appended claims.

What is claimed is:

1. A thermal conduction structure comprising:
a heat receiving portion;
a heat releasing portion; and
a plurality of actuators disposed between the heat receiving portion and the heat releasing portion such that a path is defined from the heat receiving portion to the heat releasing portion through the actuator, wherein
the actuator is movable between a first position and a second position so as to correspond to an energy supplied from outside,
the actuator is contact with the heat receiving portion and the heat releasing portion, when the actuator is in the first position, and
the path has a non-contact part between the heat receiving portion and the heat releasing portion, when the actuator is in the second position.

2. The thermal conduction structure according to claim 1, wherein
the actuator has a first end and a second end,
the first end of the actuator is continuously contact with one of the heat receiving portion and the heat releasing portion, when the actuator is in the first position,
the second end of the actuator is contact with other of the heat receiving portion and the heat releasing portion, when the actuator is in the first position, and
the second end of the actuator is disabled to contact with other of the heat receiving portion and the heat releasing portion, when the actuator is in the second position.

3. The thermal conduction structure according to claim 1, further comprising:
a support member disposed between the heat receiving portion and the heat releasing portion, wherein
the support member supports the heat receiving portion and the heat releasing portion.

4. The thermal conduction structure according to claim 1, wherein
the actuator includes a bimetal and/or a shape-memory alloy so as to be movable to correspond to a thermal energy supplied from outside.

5. The thermal conduction structure according to claim 1, wherein
the actuator includes a sack member made of an elastic material,
the sack member is sealed to have a gas therein, and
the sack member expands or contracts such that the actuator is movable to correspond to a thermal energy supplied from outside.

6. The thermal conduction structure according to claim 1, wherein
the actuator is in the first position, when the actuator has a temperature equal to or higher than a predetermined value, and
the actuator in the second position, when the actuator has a temperature lower than the predetermined value.

7. The thermal conduction structure according to claim 1, wherein
the actuator is in the second position, when the actuator has a temperature equal to or higher than a predetermined value, and
the actuator is in the first position, when the actuator has a temperature lower than the predetermined value.

8. The thermal conduction structure according to claim 1, wherein
the actuator includes a solenoid so as to be movable to correspond to an electric energy supplied from outside.

9. The thermal conduction structure according to claim 1, wherein
the actuator includes a magnet so as to be movable to correspond to a magnetic energy supplied from outside.

10. The thermal conduction structure according to claim 1, wherein
the actuator is made of a composite material.

11. The thermal conduction structure according to claim 10, wherein
the composite material is a mix of a first portion made of a first material and a second portion made of a second material,
the second material has at least one of a thermal conductivity and an electric conductivity lower than that of the first material,
the second material has a thermal expansion coefficient lower than that of the first material,
the first portion has a contact rate to be contact with other first portion, and
the contact rate of the first portion is changed when the composite material has a temperature equal to or higher than a predetermined value, such that at least one of a thermal conductivity and an electric conductivity of the composite material is changed.

12. A composite material comprising:
a mix of a first portion made of a first material and a second portion made of a second material, wherein
the second material has at least one of a thermal conductivity and an electric conductivity lower than that of the first material,
the second material has a thermal expansion coefficient lower than that of the first material,
the first portion has a contact rate to be contact with other first portion, and
the contact rate of the first portion is changed when the composite material has a temperature equal to or higher than a predetermined value, such that at least one of a thermal conductivity and an electric conductivity of the composite material is changed.

13. The composite material according to claim 12, wherein
the contact rate of the first portion is increased when the composite material has a temperature equal to or higher than the predetermined value, such that at least one of the thermal conductivity and the electric conductivity of the composite material is increased.

14. The composite material according to claim 12, wherein
the contact rate of the first portion is decreased when the composite material has a temperature equal to or higher than the predetermined value, such that at least one of the thermal conductivity and the electric conductivity of the composite material is decreased.

15. The composite material according to claim 12, wherein
the first material is a metal material, and
the second material is an inorganic oxide, a polymer compound, or a composite of an inorganic oxide and a polymer compound.

16. A method of producing the composite material according to claim 12, the method comprising:
mixing the first material and the second material, and
solidifying the mix of the first material and the second material such that the first portion made of the first material is continuously contact with other first portion.

17. The method of producing the composite material according to claim 16, wherein
the solidifying includes pressurizing the mix of the first material and the second material such that the first portion made of the first material is continuously contact with other first portion.

18. The method of producing the composite material according to claim 16, wherein
the solidifying includes
settling the mix of the first material and the second material, and
precipitating the first material having a specific gravity larger than that of the second material such that the first portion made of the first material is continuously contact with other first portion.

19. The method of producing the composite material according to claim 18, wherein
the solidifying is performed such that the first material is exposed from the composite material.

20. The method of producing the composite material according to claim 18, wherein
the composite material has a temperature set to be higher than the predetermined value in the solidifying, when the thermal expansion coefficient of the second material is smaller than that of the first material, and
the composite material has a temperature set to be lower than the predetermined value in the solidifying, when the thermal expansion coefficient of the second material is larger than that of the first material.
